(19) United States
(12) Patent Application Publication
(10) Pub. No.: US 2004/0139318 A1
(43) Pub. Date: Jul. 15, 2004

(54) Activation and personalization of downloadable content

(75) Inventors: Barry J. Fiala, Somerville, TN (US); Leslie D. Hardy, Boulder City, NV (US)

Correspondence Address: Russell H. Walker, Walker, McKenzie & Walker, P.C., Suite 434, 6363 Popular Avenue, Memphis, TN, 38119-4896, US

(73) Assignee: Digital Interactive Entertainment, LLC, Memphis, TN

(21) Appl. No.: 10/703,811

(22) Filed: Nov. 6, 2003

Related U.S. Application Data
(60) Provisional application No. 60/424,087, filed on Nov. 6, 2002.

(51) Int. Cl. H04L 9/00

(52) U.S. Cl. 713/165

(57) ABSTRACT

Methods and apparatus for inclusion of customizable or personalized digital content in digital greeting cards and other digital media, activated at a point of sale or direct purchase over the Internet. Methods for customization of the content of a digital audio or video object or objects or material, delivered as a downloadable file(s) or in streaming form, where additional or incidental content has been included based on information provided or incidental content created by the individuals involved in customizing, sending or receiving the material. These methods can be applied to digital content associated with greeting or gift cards sold through retail using point-of-sale activation or for digital audio or video material or objects purchased directly over the Internet. PIN numbers may be used with point-of-sale activation to limit unlicensed access or unlicensed copying to protect intellectual property rights.

### CROSS REFERENCE TO RELATED APPLICATIONS

Not applicable.

### STATEMENT REGARDING FEDERALLY SPONSORED RESEARCH OR DEVELOPMENT

Not applicable.

### REFERENCE TO COMPACT DISC(S)

Not applicable.

### BACKGROUND OF THE INVENTION

1. Field of the Invention

The present invention relates, in general, to methods and apparatus for point-of-sale activation of software and metered accounts, and to delivery and sale of digitally-encoded products over a global telecommunications network, and related packaging and retail presentation thereof.

2. Description of Related Art

This invention is related to the invention disclosed in Fiala et al., U.S. Pat. No. 5,918,909 (issued Jul. 6, 1999), for a Package and Card with Data-Encoded Strip and Method of Using Same, fully incorporated by reference herein. The downloadable and streaming content delivery of the present invention may preferably employ the encoding and decoding technology disclosed in Coifman et al., U.S. Pat. No. 5,384,725 (issued Jan. 24, 1995) for a Method and Apparatus for Encoding and Decoding Using Wavelet-Packets, fully incorporated by reference herein.

None of these references, either singly or in combination, disclose or suggest the present invention.

### BRIEF SUMMARY OF THE INVENTION

This document describes different related methods and processes concerning the modification, customization or personalization of an existing digital content, at or prior to the time of delivery, via a digital communications network or some other means of digital communication between devices.

The invention relates to:

Methods of customization of the content of a digital audio or video object or objects or material, delivered via the Internet or other digital communication network, whether as a downloadable file or files or in streaming form, where additional or incidental content has been included based on selections made by or based on decisions made using information that has been directly or indirectly provided or incidental content created by the individuals involved in either customizing, sending or receiving the material.

Methods of managing access to and customization of digital content that is associated with a collectable greeting or gift card that has been sold through retail using Point-of-Sale (“POS”) activation.

Methods for secure sales of customizable digital content in a retail environment using POS activation.

Methods for persistent storage of the specific customized digital content provided to a specific recipient in a central database to meet digital rights management requirements.

Methods of using customized digital greeting cards or customized customer receipts or similar methods for special promotional sweepstakes and activities.

Methods of securing the installed copy of customized digital material on the delivery device.

The invention includes methods for customizing the content of digital media that is delivered as a downloadable file or via streaming delivery over the Internet or other digital communications network or targeted digital broadcasting solution. This can be accomplished using a greeting, celebration or gift card with a unique identification code that functions as a receipt or token to allow a user to customize or personalize a set of audio or video digital objects using the Internet, an Interactive Voice Response (“IVR”) system or similar automated system prior to giving the card to the intended recipient, or that allows the content to be automatically customized based on information provided by the user or the recipient.

A special feature of some embodiments of the invention is a greeting or gift card with a PIN or account number that can be used as a token to initiate the download or streaming presentation of a personalized digital message or entertainment including digital content for the recipient of the card. The invention combines existing technology to create a powerful link between the Internet and retail.

The invention provides a PIN or code related to a unique unit of the product or which allows for the identification of a specific recipient and to combine the personalized digital content with the associated digital material to create a unique copy of the digital product for the specific recipient.

A similar method can be employed for promotional activities and sweepstakes. When making a purchase, the customer would receive a promotional greeting card, or else a unique PIN with simple instructions could be printed on the customer receipt for purchase of the product/service. In this scenario, the customer would be instructed to visit a web site or to call an IVR system, and enter their information to make use of the product as described above.

An alternate implementation of the promotional greeting card product would be to instruct the customer to look for a secondary PIN or password that will be made available to the customer by some other means, such as in print or broadcast advertising.

This feature for a secondary PIN or password can be as simple as having an airplane skywrite a PIN in the sky, optionally coupled with a retailer announcing and instructing customers, that if they have seen the PIN and URL written in the sky, to go to that URL or website and register by entering the obvious PIN and a unique receipt number from their purchase that day or over a specified time period or number of days. The customer remembers or notes the PIN that was sky-written by the airplane, and has a valid receipt number, which is provided at registration and which will be recognized and accepted by the retailer.

The invention includes methods for locking a customized digital object or objects, that will be downloaded in its (their) entirety to the recipient, to the specific device that is receiving the download and will be used for playback of the digital object or objects so that the digital object or objects cannot be copied from one device to another without significant effort. This helps to make the product more secure and protects the intellectual property rights of the owner or owners of the content of the digital object or objects.

The invention includes methods for creating a back-up copy of the unique digital material that was downloaded by a recipient so that in the case that the recipient should lose the material, it will be possible to download the back-up copy retained for that specific user without infringing on the intellectual property rights of the content owner or owners.

The content of an existing digital material can be modified, or additional content added, at the time of delivery by inserting selected complimentary material, based on personal preferences that have been previously expressed directly or indirectly by some party involved in receiving or sending the material, and stored in a database.

This invention addresses an important question often asked by the Internet business community, namely, “How do you drive customers to a website on the Internet?” One answer is the retail distribution of POS activated products that leverage the power of retail to make customers aware of the product offering while being able to purchase that product at the same time, but then driving the customer to the web site in order to take delivery of the product or service purchased.

### BRIEF DESCRIPTION OF THE SEVERAL VIEWS OF THE DRAWING

FIGS. 1, 2, 3, 4A and 4B show a first preferred embodiment of packaging and retail presentation for a point-of-sale activation product such as the present invention. FIG. 1 is a front view; FIG. 2 is a right side view of FIG. 1, the left side view being substantially a mirror image of FIG. 2; FIG. 3 is a rear view; and FIG. 4A is a rear view of the Activator Card shown removed from the carrier; FIG. 4B is a rear view of the Stored Value Product Card shown removed from the carrier.

FIGS. 5 and 6 show a second preferred embodiment of packaging and retail presentation for point-of-sale activation of multiple products combined in a single retail package. FIG. 5 is a front view; FIG. 6 is a right side view of FIG. 5, the left side view being substantially a mirror image of FIG. 6. The rear view of the embodiment shown in FIG. 5 is substantially similar to the rear view shown in FIG. 3.

FIGS. 7 through 16 show variations of the preferred embodiments of packaging and retail presentation for a point-of-sale activation product.

FIGS. 7 and 8 respectively are front and rear views of a third preferred embodiment.

FIGS. 9 through 12 show a fourth preferred embodiment. FIG. 9 is a front view of the fourth preferred embodiment; FIG. 10 is a right side view of FIG. 9, the left side view being substantially a mirror image of FIG. 10; FIG. 11 is a left side view of the fourth preferred embodiment, similar to FIG. 10 but with the bottom part of the carrier raised by folding; FIG. 12 is a rear view of the fourth preferred embodiment with the bottom part of the carrier again raised by folding as in FIG. 11.

FIGS. 13 through 16 show a fifth preferred embodiment. FIG. 13 is a front view of the fifth preferred embodiment after folding of the carrier into a compact package; FIG. 14 is a rear view of the fifth preferred embodiment of FIG. 13 after folding of the carrier; FIG. 15 is a front view of the fifth preferred embodiment with the carrier being unfolded; FIG. 16 is a rear view of the unfolded carrier of FIG. 15.

FIG. 17 shows the process workflow for implementation of a point-of-sale activated product such as the present invention.

FIG. 18 shows a preferred embodiment example of a customized collectable greeting card of the present invention.

FIG. 19 shows a preferred embodiment example of customization of a digital material at the time of delivery in streaming form, where additional or incidental content has been included based on information that has been provided by the individuals or systems involved in either customizing, sending or receiving the material as described in the present invention.

FIG. 20 shows an alternate embodiment of the invention where the purchase of a customized digital product is purchased and delivered via the Internet or equivalent digital communications network.

### DETAILED DESCRIPTION OF THE INVENTION

Referring to the drawing figures, the various features and structure of the preferred embodiments of the invention will now be described in greater detail.

First, a detailed description will be given of the personalization feature(s) of the preferred embodiments of the present invention:

We all have vivid memories associated with music from our childhood and adolescence. Those memories often include relationships with very special people, imprinted in our minds, marked by time and music. Hearing those old musical favorites can make us wonder about what could have been. What if it had been different? This invention is to create a permanent memory related to an old favorite or a new favorite, whether that favorite is a musical song or songs, or video digital content.

Simply put, the present invention is a digital product or digital content with an included custom voice mail message or personalized digital item or item or items selected from a menu of available custom content. One method of implementation of the invention is by distribution of the right to access and use a digital material that is associated with a package (30), sold through retail, adapted for POS activation, where each individual unit of the product contains a unique account number or PIN. In this example of an implementation, we will allude to this product as a greeting card, or gift card, or collectable card, or greeting/gift card, or the product. In this example, the product package contains information that will allow the purchaser or recipient to customize the material prior to download or usage, as well as a unique, human readable PIN, or user ID, and/or password that can be used to authenticate the actual purchase in the automated customization and delivery system. All embodiments of the point-of-sale activated product package (30) have many similarities, and, after describing the first preferred embodiment and its use and operation in detail, only the differences of the second, third, fourth, and fifth embodiments will be discussed in detail, it being understood that similar structures in all embodiments perform similar functions. For clarity, reference numerals for the second, third, fourth, and fifth embodiments will have respective prefixes of “2.”, “3.”, “4.”, “5.”, etc., to denote those embodiments, and similar suffixes for the reference numerals will be used to indicate similar structure between the various embodiments.

The preferred embodiment of a packaged product intended for point-of-sale activation of a stored value product is shown in FIGS. 1, 2, 3, 4A and 4B and is comprised of a package that embodies three key components: A carrier (32) adapted for retail display, a unique account number or PIN (34) in human readable form, and a machine readable activation code (discussed below) for POS activation. This first embodiment and many variants of it are shown in Fiala et al., U.S. Pat. No. 5,918,909 (issued Jul. 6, 1999), fully incorporated by reference herein. Typically, PIN (34) is obscured by the carrier (32) when the Activator Card (36) is secured to the carrier, but the PIN may instead or additionally have a peel-off or scratch-off label or covering (38) thereover to hide the PIN in a well-known manner. The carrier (32) or backing is typically made of cardboard, and is often dimensioned to fit on a standard retail display and has a perforation or hang hole (40) at the top to facilitate hanging on a well-known so-called “J-Hook” (not shown). The use of a carrier is optional, and other packaging solutions can be used. A UPC bar code (42) (the Universal Product Code (“UPC”), is the commonly used term for the bar code that is printed on most retail products in the United States. The UPC bar code (42) for each product is generated following a standard set of rules issued by the UCC that ensures that all retail products will have a unique UPC for their type that will make it possible to check out or register products at the POS terminal for sale, payment, and inventory control) will normally be printed on the back of the carrier (32) to facilitate scanning in a POS terminal (e.g., a cash register). In order to use a stored value product (30), the user must be able to refer to a unique account ID and/or PIN (34), and will commonly need instructions on how to access or request the prepaid product or service. For practical reasons, it is often useful to place the account information and some instructions on a “Stored Value Product Card” (44) that has roughly the same dimensions as a credit card, to make it easy for the user to carry the card so as to give the user easy access to the Stored Value Product/Service. The Stored Value Product Card (44) will sometimes contain a standard magnetic stripe (46) containing encoded information so that the card (44) can be used in a device such as a magnetic stripe reader or credit card reader in a pay phone. In some cases, the security of the product can be enhanced by printing an additional or complimentary PIN (48) on the back of the Stored Value Product Card (44) with the PIN (48) being obscured by a scratch-off or peel-off label or covering (50). In order to use the product, the user must scratch off the label (38), (50) to expose the PIN (34) or additional PIN (48) or password in order to use the product. This can be useful in improving the security of the product to make it more difficult to utilize an account or product fraudulently, or it can be used as a final verification by the customer where removing the scratch off label (38), (50) will invalidate the product (30) for return to the retail location for credit, or as an alternative PIN that can be used to access specific features or services, or as a promotional code, or for any other use that requires an obscure additional PIN or account number or password. A key feature for a well-developed POS activation package (30) is that a machine-readable activation code (discussed below) is exposed, and can be immediately accessed and read at the time of purchase by a device without having to open, break, or change the packaging. This makes it possible to read the activation code at the POS without destroying the packaging to reduce handling, and makes it possible to return the product to the retail shelf if the customer decides not to purchase the product, or returns the product directly after purchase. The transmission of the activation code, together with other information, to a remote activation processor is what activates the specific account of the stored value product or service so that it is available to the purchaser or user. Typical means of storing the activation code that are easily accessible in a retail environment are using a non-UPC bar code (52) or by encoding the activation code onto a magnetic stripe (54) that can be read in a standard magnetic card reader. When a magnetic stripe (54) is used to store the activation code, it is often useful to add this to the package in the form of an Activator Card (36) that is attached to the carrier in such a way that the magnetic stripe (54) can be read without opening the packaging or detaching the activator card (36) from the carrier (32).

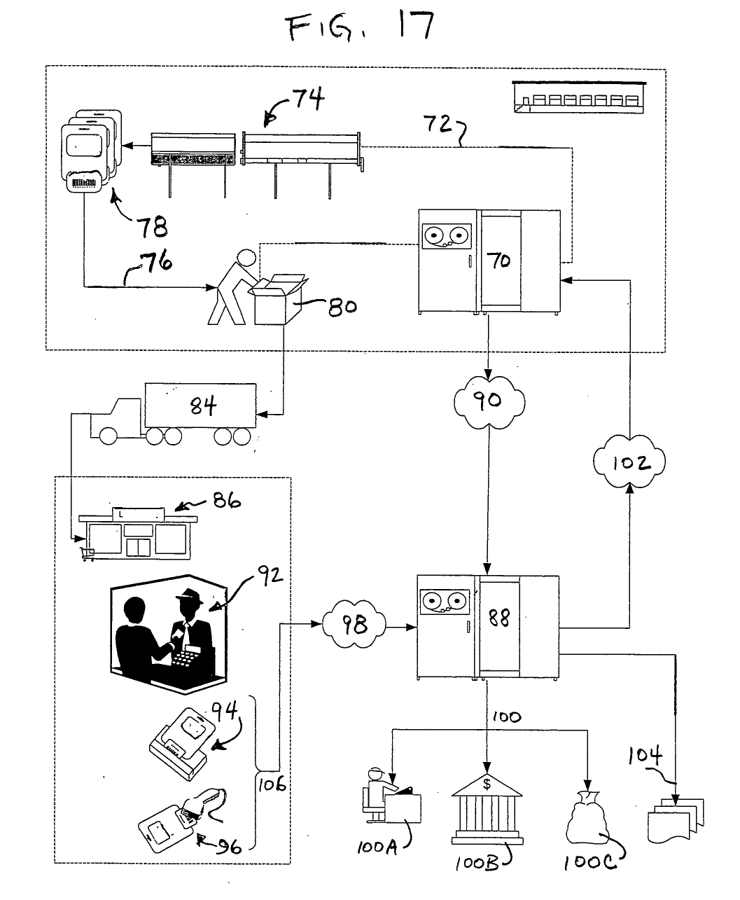

FIGS. 5 through 16 give alternate examples of the preferred embodiments of the packaging for a point-of-sale activated stored value product. It shall be understood that many aspects of the various preferred embodiments of the present invention are substantially the same, and only those differences specific to each embodiment will be discussed in detail, it being understood that similar structural features perform similar functions in all embodiments. FIGS. 5 and 6 show a special variation (2.30) of packaging for point-of-sale activation products (2.30) that makes it possible to activate multiple stored value accounts (products or services) that are sold together in a single package. In this case, multiple stored value accounts are tied to the same activation code. Thus, multiple products can be activated at the point of sale based on a single purchase and a single activation transaction. An example of such a “multi-pack” activation product is disclosed in Fiala et al., U.S. Pat. No. 5,918,909 (issued Jul. 6, 1999), fully incorporated by reference herein. The package (2.30) can contain multiple units of the same product (e.g., 10 units of 120 minute prepaid phone cards), or the package can contain two or more different products (e.g., roadside assistance insurance and a phone card) in the form of multiple stored value product cards (2.44). To accommodate these solutions, a typical package will contain two or more Stored Value Product Cards (2.44) that each represent a specific product account or different products. These will normally be stored in a clear plastic blister (2.56) that is attached to the carrier (2.32) for retail display. Even this type of product will be adapted to retail display by containing a perforation or hang hole (2.40) to facilitate hanging on a well-known so-called “J-Hook” (not shown). The machine-readable activation code can be made available as a non-UPC bar code (2.52) or as information available in a magnetic stripe (2.54) on an Activator Card (2.36). FIGS. 7 and 8 show an example of an alternative package type (3.30) that has been used in a number of instances and allows a POS activation package (3.30) to be produced by cutting the entire package from a sheet of plastic. Such a structure is shown, for example, in Blank, U.S. Pat. No. 6,588,658 (issued Jul. 6, 2003), fully incorporated by reference herein. The resulting unit is scored (3.58) and/or has a line of weakness in the middle to allow for easy separation of the stored value (and possibly activator) card (3.44). The top half of the unit now functions as the “carrier” (3.32) and a hang hole (3.40) punched into the top of the carrier (3.32) allows for easy display in retail environments using a “J-Hook”. The bottom half (3.44) of the unit can now function as both the stored value card (3.44) and activator card. In a typical implementation of this type of packaging, the UPC (3.42) will be applied to the back of the top half (3.32) of the unit (or “carrier”), and the activation code can be applied to the bottom half as a magnetic stripe (3.54) on the back of the “card” or as a non-UPC bar code (3.52), that is normally printed on the front of the card to clearly distinguish this bar code from the UPC. If desired, a PIN (3.48) with obscuring covering (3.50) may be provided. FIGS. 9, 10, 11 and 12 show another variation of POS activation packaging (4.30) where a single stored value product/activator card (4.44) is affixed to a carrier (4.32) in such a way that the magnetic stripe (4.54) on the activator card (4.44) is not visible when the package (4.30) is viewed from the rear. However, the carrier is scored (4.60) in such a way that the bottom flap part (4.62) of the carrier can easily be folded out of the way when it is time to read the activation code from the magnetic stripe (4.54) in the POS terminal as can be seen in FIGS. 11 and 12. Such a structure is shown, for example, in Williams, U.S. Pat. No. 5,740,915 (issued Apr. 21, 1998), fully incorporated by reference herein. FIGS. 13 through 16 show a different variation (5.30) of the packaging where a larger carrier (5.32) is folded to produce a compact package (5.30) having a stored value activator card (5.44) with the package (5.30) having suitable dimensions for retail display. However, a prospective customer at the retail location can easily open the carrier (5.32). This type of packaging has the advantage that it provides significantly more area for printing a description of a complex product or products, or to provide additional incentive to purchase the product, or to provide specific instructions concerning the product (e.g., a list of compatible models of cell phones for downloading pre-paid ring-tones). Still another variation of point-of-sale activated product structure is shown in Smith et al., U.S. Pat. 5,777,305 (issued Jul. 7, 1998), fully incorporated by reference herein. The particular structure of these point-of-sale activation products is well known and the present invention builds on point-of-sale activation to accomplish some of its goals. A disclosure of point-of-sale activation is given, for example, in Fiala et al., U.S. Pat. No. 5,918,909 (issued Jul. 6, 1999), fully incorporated by reference herein.

FIG. 17 gives an overview of the preferred method for manufacture and distribution of a product based on POS activation packaging as utilized for products such as the customizable greeting/gift cards that comprise one implementation of the invention. Since it is critical that every unit manufactured must have a unique account number and/or PIN and activation code, all steps in the manufacturing process are controlled or monitored by a central production management system (70) at the factory. The production management system controls and verifies that each unit meets these requirements with a direct connection communication channel (72) to the various production lines (74) in the factory, and for successive levels of packing (76) of individual products (78) via “pack outs” into inner packs, outer packs, etc. (increasingly larger cartons or boxes of products (80)) for shipping, also monitored by a communication channel (82) to the production management system. The system also monitors which units have been shipped (84), and to which destination retail locations (86) or distribution centers, to facilitate fraud control. When products are shipped, information on the account number and PIN(s) and activation code and retail location is passed to an activation processing system (88) via some form of digital communication, such as magnetic tape, or CD, or a direct connection or the Internet (90), where this information is stored in a database. When a customer purchases one of these products at a point of sale (92) of the retail location (86), the UPC bar code on the product will be scanned in the POS terminal. Normally, the POS system will be programmed to provide a message to the cashier via the POS terminal (106) that the product must be activated. Activation will normally be carried out by swiping the activator card through a well-known magnetic stripe reader (94) connected to the POS terminal (106), or by scanning the activation bar code as by using a well-known bar code scanner (96) connected to the POS terminal (106). The POS terminal (106) will be programmed to directly or indirectly, through a central POS management system, request confirmation/authorization from the activation processor (88), through some digital communication connection or network (98), that the specific unit of the product has been activated. The activation processor records the activation of the specific unit of the product in its database, and where required, also confirms the activation of the product with the third party provider (100) of the stored value product or service so as to enable account management services (100A), banking services (100B) and/or to cause funds (100C) to be made available for payments. The product is now “hot” and can be accessed or used by the customer. The activation processor can also pass information back to the production management system (70) via some form of communication (102) to allow for just-in-time production and shipment of product to replenish stock at specific retail locations or distribution centers. The activation processor can also provide sales reports, etc. (104), to the parties involved, and initiate funds transfers and/or billing between the different parties involved (e.g., if the product is being sold on consignment, and the product owner will be billing the retail organization based on current sales).

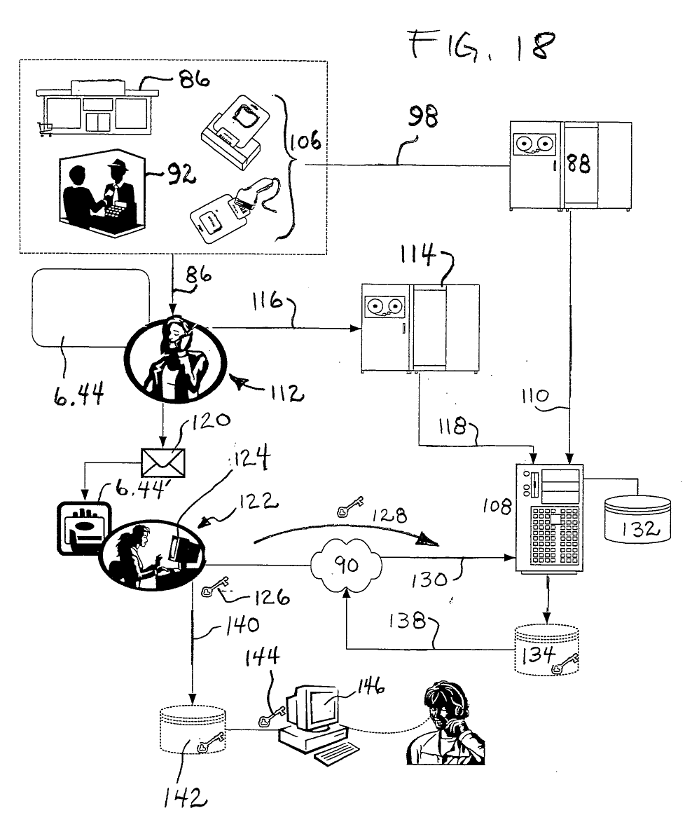

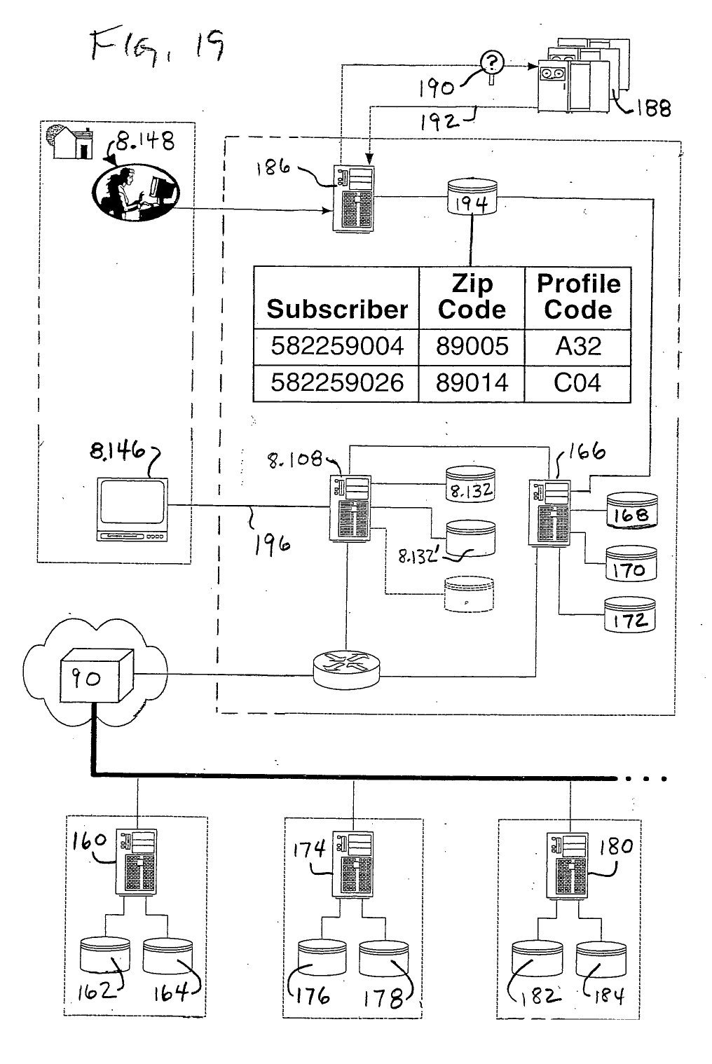

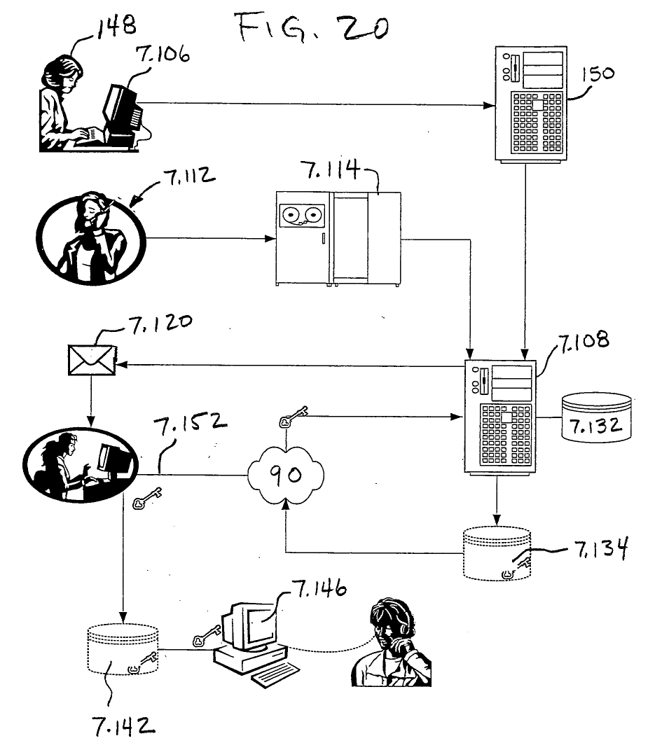

FIG. 18 gives a specific example of the methods involved in the purchase, customization, access and utilization of the digital content that is available as part of a POS activated greeting/gift card packaged product (6.44), including methods for binding the downloaded material to a specific delivery device so that it cannot easily be copied to another device. A central concept to creating such a product is to include the right to utilize, listen to, or view some digital content together with the package. This will give the holder of the package or card the right or license to download that digital content, including personal and interactive and/or custom greetings, as follows: Each package or card (6.44) of the invention has a unique account number (i.e., PIN) and/or a unique activation code that is encoded on the package or card at the time of production. The activation code on the packaged product is stored as a machine-readable code and provided with the product. Information on all PIN numbers and activation codes is stored in a database within an activation processor (88) such as a computer. When a Collector or Greeting Card product (6.44) is purchased at a point of sale (92), the activation code is scanned or read at the POS terminal (106), and an activation transaction is sent to the activation processor's system (88) from the POS terminal or central POS system through some form of digital communication (98). The activation processor confirms that this is a valid product, and records the fact that a specific account or PIN has been activated for use in the database resident in its system (88). The activation processor system (88) will notify the content management and delivery system (108) via some means of digital communication (110) in real-time as each specific unit of the product is activated. Upon leaving the retail site (86), it is now possible for the customer to utilize whatever digital product or combination of products has been purchased. Prior to the customer downloading and receiving the expected digital content, the customer (112) has an opportunity to personalize the delivered content. A computer is used to access a customization system such as through an internet web site or using a telephone to access an IVR apparatus (114) having a provided toll free (“800”) or toll charge (“900”) telephone number. The customer can dial up the IVR, or use a computer, or use well-known computer IP telephony, or use any other communications device that can access a specific website or registration handler/processor (114) through a communications channel (116). Once accessed, the registration system instructs the caller to enter the activated PIN number associated with the product that has been purchased. Once the purchased product is confirmed and registration is completed, the customer then has the capability to personalize or customize the product. Such customization could be in the form of a personally recorded message that is to be included together with the other digital content, it could be in the form of a selection of one of several optional greetings or additions to the other digital content, or it could be through the selection of one or more components from an initial list of options (such as selection two songs from a possible list of ten songs). Whatever choices the user has made concerning the customization of a specific product or has created to add to that product, as identified by its unique PIN, will be passed from the IVR (114), where the choices were gathered, via some means of digital communication (118) to the content management and delivery system (108), where they will be stored. In the case of a gift or greeting card product, the purchaser of the product will normally send (120) or give the package, or some modified (“customized”) version or component of the package to an intended recipient (122). The intended recipient (122) will review the received card or package (6.44′) and, following the instructions on the card or package will use some device (124), such as, but not limited to, a personal computer (“PC”), to connect to the content management and delivery system (108) through some means of digital communication, such as, but not limited to, the Internet (90). When the user/recipient accesses the content management and delivery system, a set of installation software will be downloaded to the user's device, or such software may have been included on a digital media in the package. This installation software will generate a binary key (126), using a software-based algorithm that will be unique for the specific device, or where the odds, that two devices will generate the same key, are extremely low. This key will be generated using standard and well known means for building such an identification key based on identification codes that are built into specific components of the device, such as, but not limited to, the hard disk, Network Interface Card (“NIC”), processor, and other components of the device with identification codes or serial numbers that can be accessed by software running on the device. One method of further increasing the likelihood that two devices will not produce the same key is to create a directory or folder or similar virtual file container on the persistent storage media (e.g., hard disk) of the device. Including the detailed date and time for the creation of this directory as one of the inputs to the key creation algorithm will increase the avalanche effect of the algorithm (likelihood of getting highly disparate results) when the key is created. The preferred algorithm will be a “ratchet down” type algorithm. This is an algorithm whose construction makes it impossible to calculate the original input or inputs even when the result and some of the input values are known. This type of algorithm is typically used to protect password files on mainframe systems. This key will be transmitted (128) over a communication channel (130) to the content management and delivery system (108). It is important to note that a persistent copy of this key will not be made on the device. The content management and delivery system will access its database of digital content (132), and also access information received from the IVR (114) for the specific account or PIN, and a customer/recipient/device specific download (134) will then be created (136) by the system using the transmitted key to encode or encrypt the contents. This unique copy (134) of the digital content, which includes the customizations previously made by the user through the IVR (114), can now be downloaded (138), (90), (140) to the persistent storage media (142) of the user's/recipient's storage/playback device (146) and installed together with a compatible software “player”. When the user wants to play or view the locally available downloaded material (142) using the accompanying player, the player software will first create the playback binary key (144) for the user's storage/playback device (146) using the same algorithm that was used during the download and installation process. Given that this is the same device, with the same components, the key that is generated (144) during playback should be exactly the same key (126) that was generated at download and installation. This key will then be used, by the software player, to decode the locally stored copy (142) of the customized digital content so that the user can listen to or view said material.

As an example, a customer could purchase a digital interactive entertainment product based on an “Elvis Presley” (or other celebrity) theme. The product, for example, could be made up of a traditional greeting card that includes a gift card for downloading an Elvis Presley song together with a special greeting selected from a number of possible greetings in Elvis Presley's voice (recorded by a celebrity impersonator), and a personalized greeting. Available greetings could be printed on the package, and could include things like: “Happy Birthday Baby”; “Happy Anniversary Baby”; “With all my Love Baby”; “Baby, you've just got to forgive me”; “Love and kisses and get well soon, Honey”; “Marry me Honey, and I'll be your Teddy Bear forever”; etc. The product may even allow the user to select which Elvis Presley song to include from a selection that could also be printed on the package. There may even be additional material that the user can select from or customize that is related to the theme of Elvis Presley such as messages intended for an answering machine or downloadable ring tones for cell phones that can be accessed separately or even from other delivery systems using the account or PIN number of the product. The stored value product card in the product would be designed to be a theme based collector card. A person intending to send some type of celebratory or congratulatory greeting would purchase the product. The purchaser would be presented with instructions on how to personalize the product, and, by following those instructions, could add a personal message in his/her own voice via an IVR or Internet-based solution, or by uploading the message in a digitized format, such as “Darling, I love you so much, I just had to ask you” and/or select a specific message, provided in Elvis's voice, to be included with the downloadable content, e.g., “Marry me Honey, and I'll be your Teddy Bear forever,” and/or select one of a number of available Elvis Presley songs, e.g., “It's Now or Never”. The purchaser would then give the product to the intended recipient. The recipient would then follow the instructions provided with the product to download the digital content, such as a music file, etc., to some local storage and playback device (e.g., a personal computer). The selected or personal voice greeting would be included in the delivery as an integrated component of the digital music file, for example, or as a separate component that is integrated with the digital music upon playback using timing codes or another well-known method of synchronization, or as a completely separate component. Also, by following the instructions included with the product, the recipient could be able to download (in digital or analog format), for example, an Elvis-related message intended for a telephone answering machine, or an Elvis-related downloadable ring tone for a cell phone.

The ability to personalize the digital content made available to the consumer to download may be related or tied to a PIN or code that is either activated by means presently used at a cash register or retail purchase location today (such as point-of-sale activation), or the PIN or code could instead be provided already activated (“hot”) in which case the “hot” PIN or code would be packaged or included in retail consumer products or promotional products for added value for the buyer. For example, a card or PIN can be included within a manufacturer's box of laundry detergent or cosmetics package. In such an embodiment of the invention, the PIN or code would be individually printed on the inside of the product carton or on a card inserted inside of a product's package. The PIN or code can be used by the buyer to access an Internet website at an indicated address (i.e., by a Uniform Resource Locator, or “URL”, of a website), or at a well-known URL otherwise known by the buyer, to register the authorizing PIN or codes and personalize and download the content as described herein for the various embodiments of the invention. The downloaded content may be generic or may be personalized as described herein. In such an embodiment of the invention, in which digital content is provided and delivered in order to provide promotional added value, the PIN could be pre-activated (“hot”) and thus would be available for immediate use after registration by the purchaser of the product (e.g., laundry detergent or cosmetics). Alternatively, the content provider might require that the PIN included with the product be provided at registration together with a unique code that is printed at purchase on the product purchaser's purchase receipt, thereby ensuring to the manufacturer that only paying customers are able to register authorizing PINs or codes, and also ensuring to the manufacturer that only paying customers receive delivery of content provided in accordance with the invention. As a specific example of this embodiment of the invention, showing how digital information and content could be delivered to a cellular telephone as an example of a receiving device for digital content, a cosmetics product could include a PIN inside the cosmetics product package together with the URL of a PIN registration and content download website, together with instructions that would direct the cosmetics product purchaser to download a free cellular telephone “ringtone” once the PIN has been registered at the cosmetic manufacturer's website on the Internet. It shall be understood that the term “ringtone” is used herein in its common usage, namely, a tone sequence that can be played by a cellular telephone when an incoming call arrives. The value to the cosmetics manufacturer would be that its paying customer would receive added value for each product purchased, and registration of the pre-activated (“hot”) PIN with the manufacturer, a step necessary for download retrieval of the delivered digital content, could be used by the manufacturer as an opportunity to obtain certain marketing research information from a customer who is known to have purchased the manufacturer's product. At registration, the cosmetics product manufacturer could selectively limit the delivery of specific content based on the unique PIN and/or printed codes provided on the purchase receipt, thereby tailoring the content delivery to the product purchased or to the purchase outlet, as desired by the manufacturer.

Although the use of POS activation packaging, and a method for securing/locking the downloaded customized digital material to a specific device are included in the embodiment described above, the primary embodiment of the invention is the ability to personalize or customize a downloadable digital content as described above. The addition of POS activation, and digital rights management controls is added as a preferred embodiment as they enhance the value and viability of the product concept that is embodied in the invention. A product as that described above could be sold through retail or over the Internet without POS activation, and without digital rights management controls, and still be an embodiment of the invention.

FIG. 20 gives an example of an alternate embodiment of the method of the invention in which no physical stored value product card (e.g., (44)) or activator card (e.g., (36)) is used, but instead the product purchase happens electronically from a user's access device (7.106), such as, for example, a personal computer, which plays the role previously played by the POS terminal (106). The user (148) goes to a URL on the Internet, and is connected to a (e.g., so-called world-wide web or “www”) purchase management server (150). In this instance, the user purchases the right to send a customized digital material to an intended recipient. Payment is made using a credit card or other standard method of payment currently utilized in making on-line payments. As part of the purchasing process, the user will select alternate components in order to customize the content of the material intended for the recipient as well as entering the recipients e-mail address. The purchase management server (150) will pass this information to the content management and delivery system (7.108) where this information will be stored in a database. If the user has determined that he/she would like to include a personal voice greeting as part of the customized digital material, the user (148) would be given a set of instructions by the purchase management server (150) on how to provide this type of greeting either via an uploaded audio file, or via an IVR system. If the personal voice greeting were to be provided via an IVR system (7.114), the purchase management server (150) would pass an appropriate set of information to the IVR system (7.114). To provide the personalized voice greeting, the user (7.112) would follow the instructions provided during the purchasing and customization session with the purchase management server (150), and contact the IVR system (7.114), and would leave a personal voice message to include in the digital material to be delivered to the recipient that would be bound to the other digital material based on a PIN or order number provided during the purchasing and customization session. The personal voice message would be passed from the IVR system (7.114) to the content management and delivery system (7.108) to be included as part of the database of digital content (7.132) managed by the system. The content management and delivery system would notify the recipient that a set of digital content is available via an e-mail (7.120). This e-mail will contain a “link” or URLs to an appropriate web page via the Internet (90) or similar digital communications network to retrieve or take delivery of the material over a communications channel (7.152) to a file (7.142) on the user's local storage device, or the user will follow instructions provided in the e-mail to go to connect to the content management and delivery system and utilize an access code such as a PIN or order number or user name and password provided in the e-mail (7.120) to download the appropriate customized digital material (7.134) to a file (7.142) on the user's local storage device. Even in this case, it would be possible to use a binary key based on information available on the recipient's device to secure the recipient's specific material/download (7.134) that is stored on the content management and delivery system, and to download this material as a file (7.142) on the user's own device (e.g., personal computer) (7.146).

When using an IVR system (114), (7.114) to access the customization system (108), (7.108), the digital content can be numbered or identified in the system and a user can be prompted to make a selection of prerecorded voice greetings or other digital content to choose from, preview, and select. The prerecorded voice greetings can be designed to be relevant to a type of music or video content that is related to a specific digital Interactive Entertainment product. The customer then instructs the customization system (108), (7.108) which of the greetings, or other digital content previewed and selected, are to be included in the product delivery by entering the associated number or code of the greeting when prompted. Examples of some choices possible are as follows:

Elvis Presley's voice, for use on a telephone message system, asks the listener to “please leave a message.”

A wrestling entertainer's voice, such as a WWF Wrestler's voice, demands that the listener “leave a message quickly” in a gruff manner.

There are an almost-infinite number of voice message possibilities.

The IVR (114), (7.114) or computer of the customization system (108), (7.108) requests that the user select a particular desired message. Then, after completing the instructions of the IVR (114), (7.114) and/or the hardware device (customization system (108), (7.108)), an opportunity may be provided to preview the personally-modified digital product on the telephone, the computer, or another hardware device, thereby allowing the user to approve the modifications and ensure that they are properly edited to blend with the content. The modifications and digital messages, and any other customer-created items, are linked to the specific numbered/identified digital product. The card product is ready to be given to the desired recipient and then downloaded and enjoyed by the recipient.

The details of a personally recorded voice greeting will now be described. After purchasing a product to obtain a valid and active PIN and related website, the customer is ready to personalize the content. With, for example, the use of a computer accessing a web site, or an IVR system using a provided “800” or “900” number, a customer can dial up the IVR, or, using IP telephony or using any other hand-held communications device, can access a website or customization processor that instructs the caller to enter the PIN number associated to the product that has previously been purchased, scanned, and activated at the point of purchase. Once the customization system (108), (7.108) is accessed as by through an IVR (114), (7.114) or internet website, it will prompt the customer to leave his or her own voice mail message that will be embedded in or delivered with the download content. The recorded greeting or message is made available for the customer to review, redo, or edit before instructing the system to accept the recording by following the provided prompts. Most recorded voice greetings are designed to be relevant to the type of music or video content related to a specific digital content. The entire process is similar to that of many well-known office voicemail-messaging systems concerning how a recorded personal greeting is created.

Applicability of the present invention for delivery of greetings by a celebrity, a celebrity impersonator, or a vocal artist for use on home telephone answering machines will now be described. This is an entirely separate feature available within a delivered digital product or sold separately for certain embodiments of the present invention. An example of such embodiments of the invention could be to offer a number of voice messages from celebrity vocalists or celebrity impersonators. By using an IVR or computer access, multiple choice, numerically selected, prerecorded celebrity messages would be offered and selected for download. A library of messages could be accessed via a website and a favorite (or several favorites based on the vended product) would be selected as offered by the product. As an example, an Elvis Presley voice impersonator could provide different and entertaining, possibly comedic, voice greetings that could be downloaded and recorded on a Compact Disc (“CD”) (or other digital or analog storage medium), just as any music or video can be transferred to CD. Using this copy, the greeting could then be played on a sound system so that the greeting could be recorded for use on a telephone message answering machine.

The consumer may use so-called “800” or “900” telephone numbers to select possibly three or four, or any other number, of predetermined greetings from a library of greetings provided for the customer or recipient of the gift card. By using a multiple choice selection, product selection would be an inexpensive process providing that the consumer has had experience with the type of product or providing that the instructions were “user friendly.” A more elaborate and personal method of specifying and/or creating an interactive greeting would be for the consumer to use an IVR system by calling a provided “800” or “900” number and following the prompts to create a personal voice message. In a manner similar to that used with well-known voice message recording devices or voice mail systems, the IVR could be used to edit and proof the personalized greetings provided in accordance with the present invention. Voice mail systems provided by telephone companies could use the prerecorded messages delivered in accordance with the present invention by simply playing the message to the voice mail recording device or using well-known techniques in these systems to upload a message or recording to the voice mail system.

Methods for creating personalized messages in accordance with the present invention will now be described. An interactive greeting or message can be provided using any of many well-known methods including, for example, use of the Internet to create e-mail, to send digital photos, and to send digital voice files. These types of messages or digital photos can be received from computers, hand-held computers, newer cellular telephones, or by using kiosks provided at retail outlets or through any other playback mechanism. Once the digital interactive personal content has been modified, created, previewed, and approved, it is sent to a database for subsequent delivery. Once in the database, the personalized data is attached, in proper order, to the uniquely numbered or coded content or digital product related to the uniquely numbered product or activated PIN or PINs. When completed, and the digital interactive message or greetings, photos, or e-mail have been embedded into the digital product, the consumer selects an individual or group to whom to give the Digital Interactive Entertainment Card or package. Such a gift is useful as a musical recording, a personal message, a personal statement or a more creative method of personal greeting than has been heretofore known.

The collector card (6.44) of the present invention will now be further described. The collector card (6.44) with a PIN allows music, or special feature video content, to be advertised, purchased, personalized, and then delivered digitally over the Internet and received by any suitable computer hardware device. This collector card becomes the focus for advertising the features of the digital product and retaining access codes and PINs related to the delivered content for future use. A graphic image of an artist, or an image related to the content, can be both decorative and utilitarian. A personalized message or greeting can be included with digital content and then the collector card can be given to a friend, relative, or employee(s). This gift can include a message or communication that is educational or suited to a particular occasion. As an example of an educational message and content, the Department of Defense (“DoD”), or a branch such as the Army, could provide an ID card to an enlisted person. On the back of the card is a PIN and URL. Because the DoD knows what PIN is on the ID card that has just been provided to a specific person, a custom music and video presentation with embedded voice and text messages related to the person's specific job or function can be provided for the person to access. The message could be updated on a random or specific time schedule. Alternatively, when received as a gift, the card becomes a tool to access and enjoy a personalized message, as well as being a permanent means of retaining the PIN or other information required to access the personalized digital content for use later in life.

As discussed herein, an important detail of some embodiments of the invention is that the downloaded copy of the digital content may have a unique numeric identification. This unique numeric identity is the feature that enables the card or PIN holder to retain his customized digital content for future downloading and/or permanent storage. The ability to retain custom content can either be provided for a period at no cost, or an account could be created for payment of fees or services required by the customer. Each unique customized downloaded product or content (134), (7.134) provided in accordance with the invention can be retained in persistent storage on the content management and delivery system (108), (7.108) or a related system with a unique identification code that is associated through a database with the specific recipient/PIN as a backup of the material. Thus, in the future, if the user wanted or needed to download the material again, it could be made available without incurring any additional royalty costs for the source material (132), (7.132) because all that would be provided to the user is a copy of his or her own specific customized copy (134), (7.134) of the material.

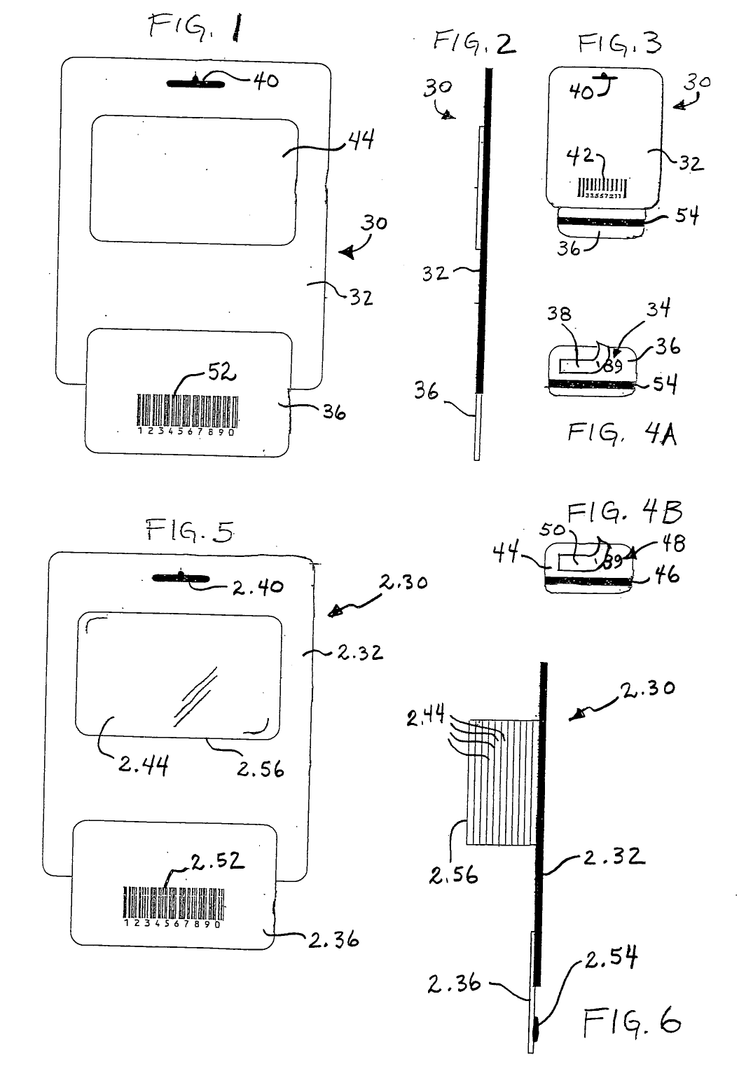

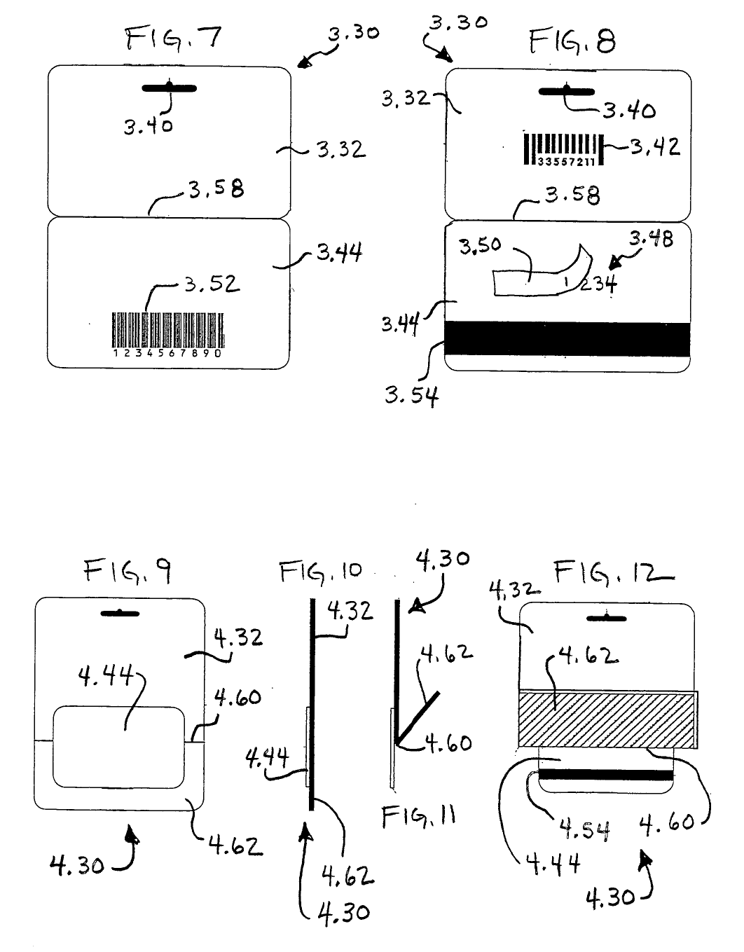

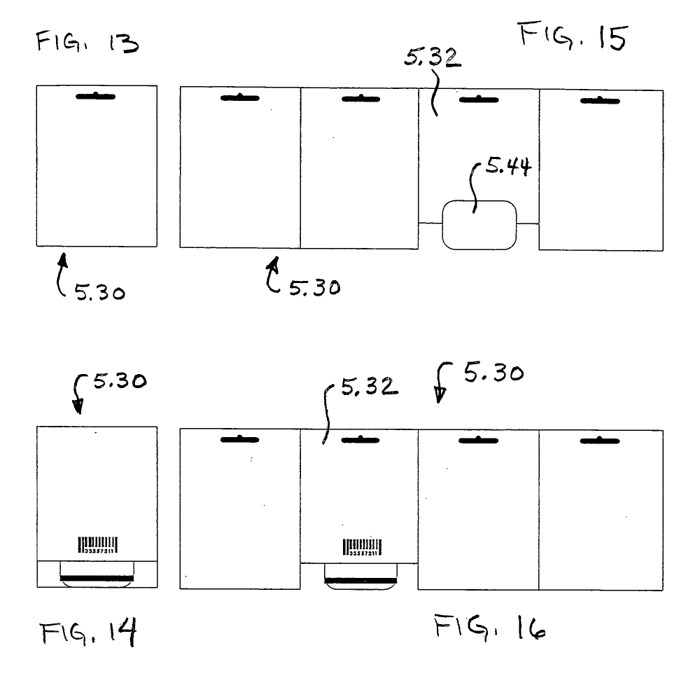

The PIN of the present invention will preferably be obscured from view (as shown, for example, by (38), (50), or (3.50) in FIGS. 4A, 4B, and 8, or as by being overlapped by the carrier (32) when the activator card (36) is secured to the carrier as in the first embodiment), in a manner that will now be described and for reasons that will also now be described. These packaged gift collector cards with an obscured PIN or PINs can hang in retail stores secured to a billboard (package) or first panel that describes the content. The collector card is secure from theft because the product cannot be used without it first being activated at the point of purchase by the seller. At the time of purchase, the PIN, or activation code or codes related to the product, is scanned or read by an appropriate hardware device at the point of purchase, reading or scanning a machine-readable copy of the code on the product, such as a magnetic strip or non-UPC bar code, or similar machine-readable format. The data encoded onto the magnetic stripe or bar code is sent though a communications network to an activation processor that manages a database, or similar information technology that is used to control access to the product. The buyer can then access the website or URL as indicated on the product, which is now “activated” or “hot”. In order to register the product, the buyer provides the PIN or authorization code, or other information requested, at the registration website whose URL is given on the card or the billboard panel or package, and the buyer is instructed to either use the product “as is” or to personalize the product by several methods described in the detailed portion of the website or printed instructions provided with the product.

The gift card of the present invention will now be described, and the gift card preferably includes a PIN. The gift card preferably has an activation strip, such as a magnetic strip or bar code that is used to activate a product associated PIN number. The point-of-sale activated number allows the package and card to be openly displayed in any area within a retail location in a secure manner because the customer cannot use the product without having first purchased the product and by having the related number activated at the point of sale. Once purchased, the Personal Identification Number (“PIN”) or PINs associated with the encoded data are activated at the register. The purchaser then provides the active PIN or PINs and other required information and receives access to goods and/or services, or software programs or other digital or analog content, authorized and delivered after registration. The PIN related to the digital files or product need not be on a card secured to a carrier panel but can be on a card alone or provided with a package and card combination. A bar code on a single piece of paper or magnetic slurry printed on paper and encoded with a related PIN or control number may also be used to activate a PIN related to a digital product. Once received at registration, the data and activated PIN or PINs and other requested information allows the full value or use of the product purchased. This packaged card and related products provide a delivery system that allows inactive product sales, prepaid authorized delivery of licensed software programs, digital information, and/or goods and services provided over the Internet, satellite communications, cable, fiber optics, and other digital communication technologies. The package can include a billboard panel for graphic presentation, a card, and can include one or more packaged components related to the offered goods and services. PIN or PINs are activated at point of purchase by using a magnetic strip, bar code, or such as well-known so-called integrated circuit card (“ICC”) or “smart card” technology (as described, for example, by the well-known international specifications given in ISO/IEC 7816-3, ISO/IEC 7816-4, ISO/IEC 7816-5, etc., for intelligent payment card technology developed by the international consortium of Europay, MasterCard, and VISA (“EMV”)) included on a card attached to the package or card within a package. PINs can also be activated and delivered by a vending device, such as, for example, a kiosk, capable of producing a PIN or PINs at the point of purchase. Such a vending device can be programmed with active PINs or can access such PINs through an online connection, and only printed and delivered and collected after purchase. Such a vending device can be used to create and/or select personalized voice, text or picture messages, or a combination of all or some of the mentioned types of message greetings. As mentioned, prior to purchase, the PIN or PINs are inactive or of little or no value as related to the goods or services provided after purchase. Inactive (“Cold”) inventory prevents unauthorized use of a product until purchased or activated, at which time the product becomes usable (or “Hot”). Such a feature ensures that goods or services offered for sale cannot be used or copied without first being purchased. Additional security measures are not necessary because theft, pirating, copying, or transferring the goods and services is made more difficult. The invention provides a method of validation providing copyright or royalty control of digital goods and services by requiring a secure and authorized PIN and/or other specified codes, PIN or PINs associated with digital content provided at the point of sale. The collector cards or collector PINs or codes need not be point-of-sale activated to be used to deliver the invention to the end user or product purchaser.

As a variation on these collector cards/gift cards just described, parents could give their children and relatives a stored dollar value gift card, activated for the parents at the point of sale, that also would have a musical or seasonal voice message which could be retrieved, and the gift card value spent for goods/services, using the PIN number provided on the gift card. Such gift cards could also be used as corporate holiday gift cards whereby uniform cards, with PIN numbers and usage instructions and access telephone numbers, could be given to a firm's employees or customers, such that the recipient could retrieve recipient-selected songs or other content such as compact discs, streaming video, etc., for download simply by using the value pre-credited on the gift card. The president of a company could also record a message to the recipient that would be played when the recipient dials an IVR access number (or accesses a content delivery web site over the internet), and the president's message could provide instructions to the recipient on how to select content for delivery. In such a manner by the use of this embodiment of the invention, corporations could maintain a ready inventory of gift cards for personalization and distribution, and, because the donor corporation could control the inventory of such gift cards, it would not be necessary to have those cards be point-of-sale activated, and the cards could simply be stocked as “hot” cards by the corporation, ready for distribution as gifts.

By using separate industry-standard (“ISO”) tracks on the magnetic stripe (e.g., (54), (46), (2.54), (3.54), (4.54), etc.) for different functions, a single product card (e.g., (44), (36), etc.) can serve multiple purposes as a well-known debit card and/or also as a stored value product card as herein described and/or as an activation card (e.g., (36), (2.36), etc.) as herein described.

The present invention preferably can also provide for pre-purchase sampling of content by a prospective purchaser, as will now be described. In most large retail music stores there are listening devices at many locations within the store. The purpose for these listening stations is so that the inventory of CDs or products can be sampled or evaluated prior to purchase. The theory is that, if someone wants to hear the latest song by an artist, they should be provided with the ability to preview that music and that, after hearing the new music, might decide to purchase that music. The present invention requires less time to preview content in its entirety because there could be only a few songs per product initially. The songs or a portion of the songs can be listened to on telephone in a short period of time. A key feature is that certain embodiments of this invention can be personalized to be a digital gift card and package, and the need to preview will be less pertinent to sales of the product. However, as a part of some embodiments of the present invention, a consumer can be provided with a method by which a preview of the product is made available without purchase. A telephone number could be provided on the packaging as well as a specific product code. This information can be titled “Preview Product.” By using a cell phone and by calling the provided number to access an IVR system, a prospective purchaser would be prompted to enter a product code to receive a preview of the product. With such a product preview, a possible problem could be continued previews of a popular song. To solve this problem, when a prospective customer previews product content on a cell phone or land line, only parts of the content might be made available for preview because phone time will be expensive, and including the complete song or songs will dilute the demand for the product. An additional method of limiting the per-person number of times a prospective customer can listen to a preview would be by systematically blocking out a calling telephone number (using well-known “caller ID” technology) so that a calling number accessing the same product code twice will be locked out of further previews of that particular product code. Video and audio content can be previewed over the Internet from home or hand-held computer.

An interesting attribute, once a unique code or PIN has been verified as active or purchased, is that the IVR or computer system can be used to deliver digital terms and conditions. By using the provided access number provided on the package or within the store a customer can then register and provide the UPC and receive the most current terms and conditions related to the product. As products become more conditions regulated, digital content which can be changed instantly within the delivery device eliminates the need for constant label and packaging changes mandated by the government. This method is used to provide a snappy jingle to advertise the features and benefit of a product or a hazardous material warning or other product dangers. If a unique code is used to verify the purchase, registration can include a value-added coupon or other premium. Either a unique numeric identity is used to provide information critical to metered accounts, or brand-related selected information can be provided video or audio depending on the hand-held device used. Critical information can be provided even to the illiterate in any selected and available language and a voice signature can be required by having the customer provide a special number (e.g., a government-issued social security number), or personal information can be provided by the customer for certification and future reference that, in fact, the digital content has been heard and understood by the customer. For example, a customer buys a box of ant poison. He notices a banner on the ceiling with a toll-free telephone number and instructions stating that information about all the products in the store can be accessed along with their promotional material or product warnings simply by calling the toll-free number. This information is made available by following IVR instructions or visual prompts so that, once it has been set up in the system, a UPC code can be entered by the customer and all or some of the advertising or warning material can then be heard in any selected language. Once the product has been purchased, the customer can use this same system because the telephone number and instructions on how to use the system would be printed on the receipt or on the product's package. A method of registration could optionally have the purchaser's telephone number captured together with other purchaser-provided personal information that is then stored and archived for proof that the customer received critical product information. The advantage to the product manufacturer of product registration also serves the customer by providing easy access to all of the critical information related to the product and, especially useful if litigation results, an archived digital certification can be provided for the manufacturer that shows the consumer's understanding and/or receipt of the product information. This telephonic advertising method can be as broad as a having a huge mall with a common Frequently Asked Questions (“FAQ”) telephone access number prominently displayed. Once accessed, the system prompts the user to say or enter the in-mall store number or name. Once the store is identified and its information accessed, the UPC code or any additional similar, or unique code, once indicated or entered by the customer, would cause the system to provide desired related product advertisement or nutritional information. The largest model, of course, would be the “1-call-digital” and, once accessed, the system asks for voice prompt for the participating retailer, the retailer's location or zip, and the retailer's UPC or other codes, and then provides the related information and also records a digital certification of receipt by the customer of important information for future reference. All this information can be provided in any selected language regardless of the bulk of the information, and such a system allows instant changes without the usual manufacturer's cost to replace obsolete graphics or packages.

FIG. 19 shows a preferred embodiment of the method of the invention as it relates to purchasing and/or viewing audio or video material that is provided through a digital network in the form of streaming data that is intended and formatted for play only while connected to the network, and which is not intended for persistent storage on the user's device. This solution can be used in digital communications networks or broadcasting system where it is possible to order audio or video on demand over the Internet, or other, and possibly as yet unknown high-speed digital communications network or similar method for digital communication. As an example, a user (8.148) establishes a relationship with a company who provides a high-speed digital connection to the Internet or some similar type of digital communications network and also provides local content management services. By content management services, we are referring to a provider of access to digital material such as audio or video content that is attractive, and of interest to the user, and who manages all aspects of licensing the rights to play or view a specific material and accessing this material from a content owner or access management system as a proxy for the user and provides the local delivery of this material to the user so as to facilitate and ease the user's access to this material and payment of required fees. The content manager would maintain a local content management system (8.108) that would maintain a continuously-updated database of available content (8.132). The information in this database would track what content (162), (164) is being offered by various content owners' or other content providers' royalty/access management systems (160) at any time, and would categorize and index this information so as to facilitate the user in finding what they are interested in at any particular time. In order to minimize traffic across the main backbone network, the local content provider could also choose to cache popular (frequently accessed) content locally (8.132′). At the same time, the content manager would maintain an advertising content management system or server (166) The advertising content management system would also maintain a database (168) of available advertisements including information on the demographic profiles that these advertisements are targeted to, and could also include a local cache (170) of frequently-accessed advertisements. Information on available advertisements, and the current price for presenting these advertisements to viewers who meet particular demographic profiles would be collected into a database (172) over a wide area network (“WAN”) or internet backbone (90) from databases (176), (178) on various advertising content servers (174) or from databases (182), (184) on advertising brokerage or advertising bidding systems (180). As part of the initial set-up of the user's account, the user will be asked to provide some information on his/her/their preferences and interest. This could be done, by the user (8.148) utilizing a computer or IVR system and passing the information to the content manager's profiling system (186) that will build a profile of the user. The profiling system could also access external information resources (188) such as that provided by the Bureau of the Census, or by commercial marketing information companies such as Equifax, Experian, Axxiom and Clarion, by making a query (190), based on the specific individual user, to collect specific data element(s) that are publicly available, or using the geographic location and/or other variables describing the user to request estimated marketing demographic elements which would then be provided over a communication channel (192) to the profiling system (186). Utilizing all available information, the profiling system (186) would create a standardized profile of the user/users/household, which would be stored in a profile database (194). The information stored in this database need not contain any information that would reveal the identity of the user. As an example, the standard profile could be accessed using the subscriber ID, but would not contain any name, address, phone number, or personal ID numbers. As the user makes use of the content manager to access available content, general information on the content selected could be used to update the profile of the user in the profile database (194) to improve the quality of targeting of advertisements or other complementary information that the content manager is providing to the user. The user would access available content using a device (8.146) such as, but not limited to, an Internet capable TV or Internet device that could be connected to a TV, or computer that could be connected to a TV. The user would access the local content provider's content management system (8.108) as his/her “home page” e.g., based on setting entered during an initial set-up of the connection) through a high speed digital connection to the Internet or other open network, or through a point-to-point connection directly to the local content provider, or via a cable TV based network (196). At any time, the user could choose to peruse the list of available content which could be displayed as a hierarchical informational tree structure categorizing the different types of content available or by searching the content database (8.132) using key words. As an example, the user could be interested in financial market news and analysis in Spanish. The content management system (8.108) would allow him/her to do that. As an example, there might be a program available from the Wall Street Journal, in Spanish, that was updated 15 minutes ago, and one from the Economist that was updated 20 minutes ago. The user would select the program of greatest interest to him/her from the available content. Once the content is ordered, the content management system could give the user the alternative of paying for the program or of watching the program with advertisement (or even with various amounts of advertisement). It may even be feasible, that if the user is willing to include enough advertising, the content manager will even credit his/her bill a modest amount for watching the program. In order to provide the user with the most relevant and useful advertisements for the specific user, content manager or Content Service Provider's (“CSP”) content management system (8.108) would interrogate the advertising content management system (166) for appropriate material. Utilizing information in the profile database (194), the advertising content management system (166) would select the most appropriate advertisements available based on the interest of the user and the current fee that the advertiser is willing to pay for presentation of the advertising to a particular market demographic. While the user is viewing the selected program, the CSP would include appropriate advertisements in the streaming video material being sent to the user's viewing device (8.146). At the same time, the content management system (8.108) and advertising content management system (166) would be passing information to a central accounting system that would keep track of the user's own account, as well as royalties to be paid to content providers, and fees to be charged to advertisers. This concept could be extended in the future by the CSP auctioning off the available advertising time based on a standardized marketing demographic profile of the user (which would not need to contain any identifying information on the user) through an automated brokering or advertising bidding system (180).

The following terms and phrases, when used herein, are defined as follows:

Branded PIN: Any PIN presented at vendor's or licensee's “brand name” URL will provide the customer with the related digital content, providing all the required information has been included at registration. Example: The vendor's PIN and a unique number on a purchase receipt are used as an identifier to allow delivery of content from that vendor.

Download: A method of sending digital information or content, either delivered over the Internet, via wireless, or any means of communication known today, or any means for delivery of digital content that may replace these existing technologies.

Digital Content: Digital content refers to any form of audio or video or audio/video material that is stored in digital format so that it can be downloaded as a file or files via the Internet or other point-to-point connection, or that can be played or viewed by streaming the content over the Internet or other point-to-point connection without requiring that the content be permanently stored on the receiving device or player or viewer.

DVO—Digital Versatile Object: A DVO is a virtual or electronic “container” for storing audio and/or video content in a highly compressed form, using any compression/decompression (“codec”) technology, such as, for example, the compression/decompression technology disclosed in Coifman et al., U.S. Pat. No. 5,384,725 (issued Jan. 24, 1995) for a Method and Apparatus for Encoding and Decoding Using Wavelet-Packets, fully incorporated by reference herein. The ability to decompress the content “on the fly” allows the digital content to reside on a computer's local storage media (“hard drive”) while retaining a small (compressed) footprint of storage space. As an example, a typical DVO might require 7.7 Megabytes when stored in a DVO (compressed) format, which could include both audio and images, but, when stored in a standard (uncompressed) digital audio format, such as lossless MP3 encoding, the audio portion might requires about 90 megabytes of storage space.

Digital content includes, but is not limited to, the use of DVOs.

Elvis Presley: The celebrity name “Elvis Presley” is used herein simply as an example of an artist or celebrity, living or dead, portrayed either by themselves or by a celebrity impersonator, for the purpose of providing interesting or entertaining customizable content for use with the present invention.

IVR—Interactive Voice Response system: The term “IVR” is used herein to refer to a telephony system that allows a user to enter information or indicate preferences or selections by using audio instructions and menus where the user can respond using the keypad or dial to indicate the number of the selection desired or can respond using voice commands that the system can convert to selections or by including verbal instructions that will be interpreted later by a human being as well as the ability to record messages or audio that can be digitized and included as part of the delivery of a digital content. The term IVR is used herein to describe this method of communication irrespective of whether the implementation is via a standard telephone network or cellular telephone network and compliant telephone device, or whether it is carried out over the Internet (a/k/a “Internet telephony”) using a suitable device for such a connection, or via some other as yet unknown means of providing a point-to-point connection for the express purpose of voice or audio/video communication with an automated response system.

PIN—Personal Identification Number: The term PIN is used herein to indicate a unique number or code or serial number or combination of these that is associated with or printed on or recorded on a specific unit or license or package in either human or machine readable formats.

URL—Universal Resource Locator: A URL refers to an addressing method that has been implemented on the Internet that allows the publisher or a WWW (World Wide Web) web site to give each page of the site a unique address that will allow a user of the Internet to find that page or that will allow links to be made that will allow a user to go to that page in an Internet browser. The term URL is used herein to indicate such an Internet address, but also refers to any similar existing or as yet unknown technology that is used to address web pages or similar constructs or alternate or related solutions for addressing such as HTTP or TCP/IP addresses.

Although the present invention has been described and illustrated with respect to preferred embodiments and preferred uses thereof, it is not to be so limited since modifications and changes can be made therein which are within the full intended scope of the invention.

We claim:

1: A method of purchasing and personalizing downloadable content, said method comprising the steps of:
(a) providing a first computer server having an archive of downloadable content;
(b) providing said first computer server with a set of customized choices over a first communications channel for configuration of said content;
(c) personalizing said content according to said set of customized choices and creating a customized download portion of said content encoded for retrieval using an encryption key;
(d) downloading said customized download portion of said content into a content playback apparatus; and
(e) decoding said downloaded customized download portion of said content using said encryption key.

2: The method as recited in claim 1, in which said providing of said first server with said set of customized choices is by a human user interacting with an IVR over a telephone communication channel.

3: The method as recited in claim 1, in which said providing of said first server with said set of customized choices is by a computer communication over the internet.

4: The method as recited in claim 1, in which a recipient is notified by an email that said customized download portion of said content is available, said email including retrieval instructions for said recipient.

5: The method as rectied in claim 1, further including the step of providing a product card to a first person, said product card having a PIN thereon and instructions for downloading of said customized download portion of said content, and then permitting said downloading of said customized download portion of said content only after said first person communicates said PIN to said first server.

6: The method as recited in claim 5, in which said method further comprises the steps of providing a metered account, and then permitting purchases to be made using funds in said metered account only after said PIN has been communicated to said first server.

7: The method as rectied in claim 1, further including the steps of:
(a) purchasing a product card having a PIN thereon, said PIN being associated with a corresponding download account on said server, said corresponding download account on said server being inactive prior to point-of-sale activation when said product card is purchased; then
(b) permitting customization of said customized download portion of said content only after said PIN has been communicated to said first server subsequent to said point-of-sale activation.

8: The method as recited in claim 7, in which said method further comprises the steps of providing a metered account, and then permitting purchases to be made using funds in said metered account only after said PIN has been communicated to said first server subsequent to said point-of-sale activation.

9: The method as recited in claim 1, in which said providing said first computer with said set of customized choices is based upon a demographic profile of a user.

10: The method as recited in claim 9, in which said demographic profile of said user is updated as said user downloads said customized download portion of said content.

11: The method as recited in claim 9, in which said customized download portion of said content includes advertising targeted for said user based on said demographic profile of said user.
